(19) United States
(12) Patent Application Publication
(10) Pub. No.: US 2003/0051312 A1
(43) Pub. Date: Mar. 20, 2003

(54) Pressure-ball sliding doorstop

(76) Inventors: Peter Hoffmann, Overath (DE); Gundolf Heinrichs, Remscheid (DE); Ralf Duning, Solingen (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/258,897

(22) PCT Filed: May 17, 2001
(86) PCT No.: PCT/DE01/01896

(30) Foreign Application Priority Data
May 20, 2000 (DE) 100 25 185.4

(51) Int. Cl. E05F 3/20

(52) U.S. Cl. 16/50

(57) ABSTRACT

The invention relates to a doorstop, in particular for motor vehicles with a door retaining rod (1), arranged parallel to the door pivot, pivoted on a door assembly piece, door, or door column and a retainer piece (2) fixed to the other door assembly piece, whereby said retainer piece (2) and the door retaining rod (1) which passes therethrough are movably connected to each other by means of a stop device which determines particular door opening positions. The stop device comprises brake- and/or stop bodies (3), which are movably supported in the retainer piece against a spring force relative to the door retainer rod (1) and are thus pre-tensioned against brake ramps (4) and catch depressions (5) on at least one side of the door retainer rod (1), arranged perpendicular to the direction of movement. The retainer piece (2) comprises a plastic housing (10) with an opening (13) for the door retainer rod (1) and openings (25), perpendicular to the above opening and parallel to the pivot axis, for the brake and/or stop bodies (3) which slide therein. The brake and/or stop bodies (3) are sliding bodies in the form of a hollow cylinder (19), closed at one end by means of a semi-circular cap (14), which in the open end thereof accepts a pressure spring (12) which bears on the closing cap (14).

The invention relates to a doorstop, in particular for motor vehicles, having the features of the preamble of claim 1.

Such doorstops are known in the state of the art, having pivotally mounted brake and/or stop bodies in the form of catch rollers, roller-shaped elements or balls, for example. Thus the publication EP 0 643 185 A1 discloses a doorstop having a catch roller as brake and/or stop body and a ball as abutment on the other side. EP 0 816 612 A1 describes a doorstop having axially supported races as brake and/or stop bodies. DE 43 25 555 A describes such a doorstop having a brake and/or stop body in the form of a roller. All doorstops have separate bearing and/or retaining elements for the rolling brake and/or stop bodies. Such doorstops are also known, in which the brake and/or stop bodies are designed not as rolling components but as sliding bodies, which are guided in the housing by means of a separate guide piece.

The need to provide separate bearing and/or retaining elements and the need for guide pieces extends the chains of tolerances of the interacting functional parts and increases the overall dimensions of the doorstops. The construction and function moreover becomes complex and expensive.

The underlying technical object of the invention is to design a doorstop of the type described in the introductory part, so that for the smallest possible overall dimensions and weight it is capable of flexibly absorbing high fixing forces and stop moments within tight dimensional tolerances with the least possible contact pressure per unit area between door retaining rod and brake and/or stop bodies.

This object is achieved in that the doorstop described in the introductory part is developed with the features of claim 1.

The doorstop according to the invention is light and compact and flexibly absorbs high stop moments within small tolerances and advantageously allows the door retaining rod to swivel out perpendicular to its clamping direction due to the brake and/or stop bodies acting in opposition, without tilting the point of contact in the process. The cylindrical part of the brake and/or stop body, in which the spring is accommodated, has a length which advantageously permits guiding without tilting.

In one embodiment having a truncated dome head, the point of contact between brake and/or stop body and door retaining rod is advantageously enlarged in such a way that it consists not just of a point or, in the case of a groove with complementary profile, not just of a contact line, but of a contact area. By enlarging the bearing surface, the contact pressure per unit area is correspondingly reduced for the same stop forces, so that the brake and/or stop bodies may advantageously be made of plastic.

If the pressure spring in opposition to the metal frame is supported on the end face of the housing, the relaxation occurring in the case of plastic and hence any resulting play between the functional elements is thereby advantageously avoided.

One embodiment in which the door retaining rod has a plastic-covered metal core allows high stop forces to be absorbed and advantageously avoids the generation of loud noise. Forming the brake ramps and the catch depressions through or between local thickenings of the plastic covering on the metal core represents a simple way of arranging them on the sides of the door retaining rod facing the pivot axis.

The arrangement of a continuous longitudinal groove with a complementary profile to the cap through brake ramps and catch depressions forms a precise lateral guide for the brake and/or stop bodies over the entire length, without increasing the contact pressure per unit area.

The integral design of an abutment or limit stop on the door retaining rod corresponding to the open position of the door advantageously permits a precise construction, in which additional toleranced components can be dispensed with. Swiveling the door and the resulting longitudinal displacement of the door retaining rod in relation to the housing of the retainer piece lead to a swivel movement of the door retaining rod about its pivot axis. An embodiment, in which the walls of the opening arranged perpendicular to the guide openings have arches over the width of the opening, which guide the door retaining rod laterally and the convexly rounded dome heads of which are arranged on a level with the center axis of the guide openings and align with their inner wall, advantageously allows the door retaining rod to swivel out.

An embodiment in which the bearing eye is extended by forming the metal core parallel to the pivot axis advantageously allows very high stop forces to be absorbed. If the opening is dimensioned so that the door retaining rod can be introduced with its end having the bearing eye foremost, this advantageously means that the door retaining rod can have an integral abutment at the other end without this impeding assembly.

Designing the closing cap of the brake and/or stop body with approximately equal wall thicknesses advantageously allows the brake and/or stop bodies to be efficiently manufactured from plastic by the injection molding process whilst ensuring high strength and stability. Designing the outer surface of the cylindrical part of the brake and/or stop bodies with channels running in the direction of movement permits a favorable distribution of slide lubricants and reduction of the contact surface and hence the frictional resistance between brake and/or stop body and inner surface of the guide opening, without adversely affecting the precise and tilt-free guiding of the brake and/or stop bodies in the cylindrical guide opening.

The provision of underside fixing apertures in the metal frames for fixing the doorstop to a door assembly piece advantageously permits an alternative design with internal thread or with press-in screws affording a highly flexible variation of the hole piercing.

The integral arrangement of cushions of elastic material on the upper end surface of the housing reduces the overall dimensions and allows the doorstop to be designed using fewer parts.

The aforementioned and other advantages of the invention will be explained in the description of exemplary embodiments, which are represented in the drawing attached, in which:

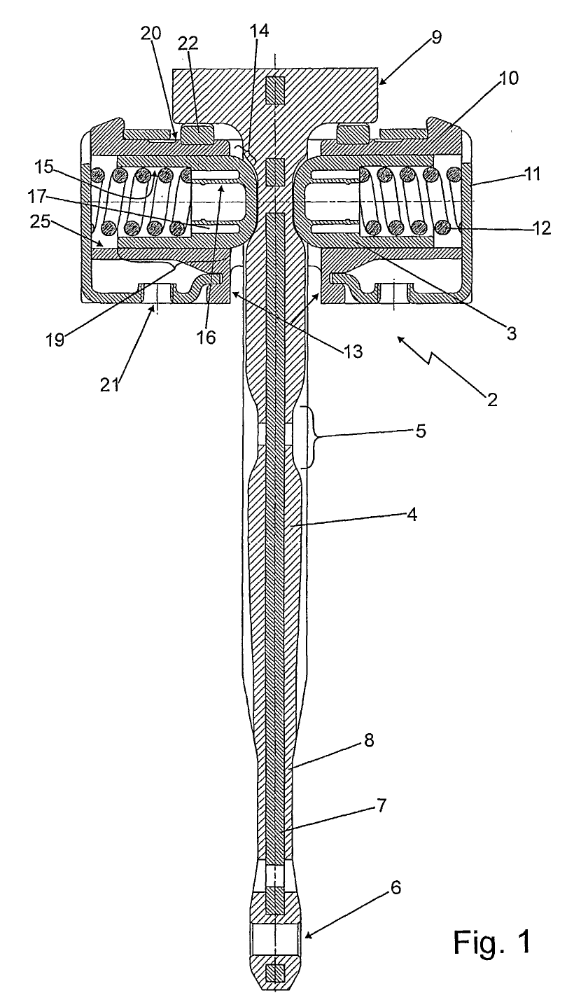

FIG. 1 shows the doorstop in a sectional side view parallel to the pivot axis with door retaining rod passing through the retainer piece;

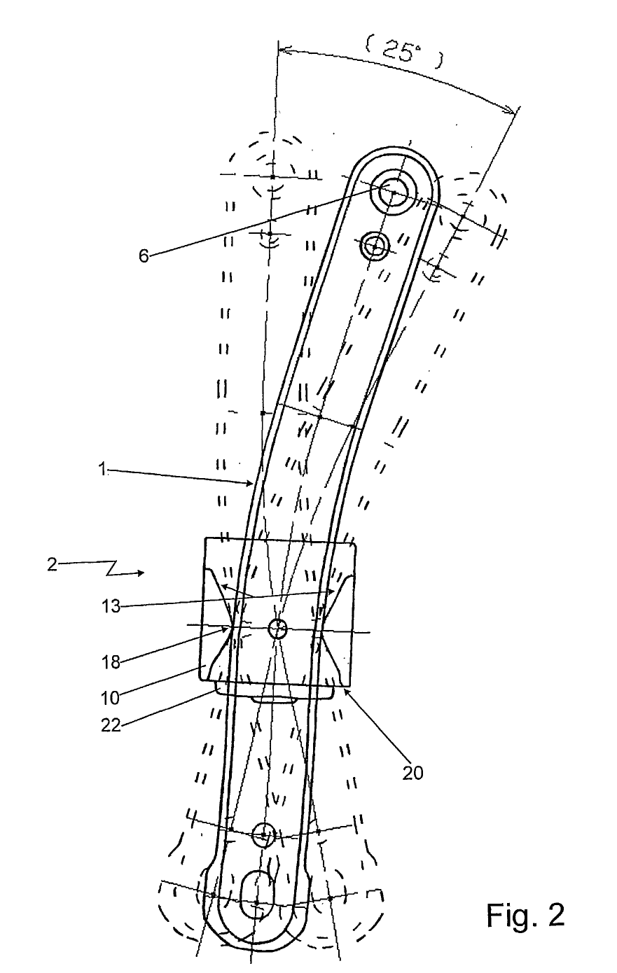

FIG. 2 shows a diagram of the doorstop in a side view perpendicular to the plane of FIG. 1 and

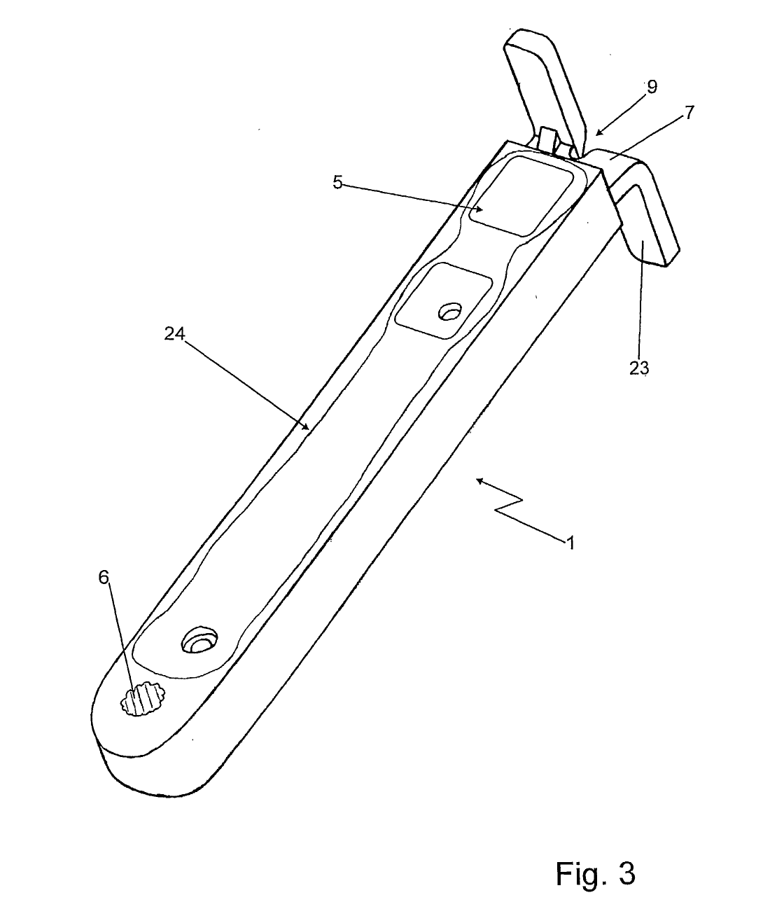

FIG. 3 shows a perspective view of the door retaining rod.

FIG. 1 shows a sectional side view of a doorstop according to the invention, the plane of section running through the doorstop parallel to the pivot axis and the door retaining rod 1 passing though the retaining piece 2. At its bottom end in the figure, the door retaining rod 1 has a bearing eye 6 and at the other end an abutment 9. The door retaining rod 1 is constructed from a metal core 7, for example a flat steel section, which is covered with plastic. The plastic covering 8 is applied with different thicknesses over the length and forms bulges in the form of local thickenings, which form the brake ramps 4 and the catch depressions 5 between the bulges. In the exemplary embodiment shown, the abutment 9, which forms the limit stop corresponding to the open position of the door, is of integral T-shaped design. The abutment 9 or the limit stop may also be alternatively formed by a pin, which is arranged through a corresponding opening in the door retaining rod 1 in the direction of the pivot axis. The brake ramps 4 and the catch depressions 5 are formed on the sides of the door retaining rod facing the pivot axis. In the position shown the brake and/or stop bodies 3 bear bilaterally preloaded against catch depressions. The door retaining rod 1 is led through the opening 13 in the housing 10. The brake and/or stop bodies 3 are guided in guide openings 25 arranged perpendicular to the opening 13.

The brake and/or stop bodies 3 take the form of hollow cylinders, which are sealed at one end by a semi-spherical cap 14. In their open end they accommodate a pressure spring 12 resting on the closing cap 14, the spring being supported on a side wall of the housing 10. The end faces of the housing 10 are enclosed by U-shaped metal frames 11, which also constitute the supporting wall for the pressure springs. The brake and/or stop bodies 3 have a central bore 16 accessible from their cylindrical cavity 15 and further bores 17 arranged in a circle around this. The shape and arrangement of the bores 16 and 17 permit approximately equal wall thicknesses in the semi-spherical cap 14. The semi-spherical cap 14 is truncated at its front end. The approximately equal wall thicknesses provide an advantageous prerequisite for manufacturing the brake and/or stop bodies from plastic by the injection molding process. In its cylindrical part 19 the outer wall of the brake and/or stop bodies 3 is fluted in the direction of movement, thereby on the one hand ensuring a favorable distribution and transmission of slide lubricants and on the other reducing the bearing surface of the cylindrical part 19 on the inner surface of the guide opening 25 and hence frictional forces occurring when the brake and/or stop bodies 3 slide in the guide opening 25.

Cushions 22 of an elastic material are integrated into the upper end surface 20 of the housing 10, against which cushions the abutment 9 resiliently strikes when the door is in the open position. Fixing apertures 21 are arranged in the bottom end surfaces of the metal frames 11. In the exemplary embodiment shown these have an internal thread for fixing the retainer piece to a door assembly piece by means of threaded screws. Press-on screws, not shown here, can also be used for fixing, however. It will be obvious that in the embodiment of the housing 10 and metal frame 11 shown there is a high degree of flexibility in the choice of hole spacing and hence in the hole piercing variants.

FIG. 2 shows a doorstop having a door retaining rod 1 that differs from the exemplary embodiment in FIG. 1, the plane of the figure being perpendicular to that in FIG. 1. The door retaining rod 1 passes through the housing 10 and is inserted through the opening 13 in the housing 10. At the same time it is laterally guided by the arches 18 on their convexly rounded dome heads. The shape and dimensions of the opening 13 allow the door retaining rod to swivel perpendicular to the pivot axis. A central swivel position of the door retaining rod 1 is represented by unbroken lines, while the dashed lines on either side thereof represent the extreme swivel positions of the door retaining rod 1 to both sides. In this embodiment the swivel range is designed to be approximately ±12.50, that is a total of approximately 25°.

In this representation the stop cushions 22 can be seen integrated into the upper end surface 20 of the housing 10. The circle indicated at the point of intersection of the three centerlines of the door retaining rods 1 corresponds approximately to the bearing surface of the truncated caps of the brake and/or stop bodies 3 on the sides of the door retaining rod 1 having the brake ramps 4 and catch depressions 5. Since they are situated on a level with the opposing dome heads of the arches 18, this point of intersection also represents the swivel axis of the door retaining rod 1 for its swivel movements perpendicular to the pivot axis.

FIG. 3 shows a perspective view of a door retaining rod 1. The bearing eye 6, with which the door retaining rod 1 is pivoted on a door assembly piece, is arranged at the bottom end of the rod as shown in the figure. The abutment 9, which is here integrally formed by right-angled deflection of the two lateral halves 23 of the centrally divided metal core 7, is shown at the other end of the door retaining rod 1. A guide groove 24, the profile of which is designed to complement the apex of the truncated semi-spherical closing cap 14 of the brake and/or stop body 3, runs in the longitudinal direction of the door retaining rod 1 over the catch depressions 5 and the brake ramps 4.

### Reference Numbers

1 Door retaining rod

2 Retainer piece

3 Brake and/or stop body

4 Brake ramps

5 Catch depression

6 Bearing eye

7 Metal core

8 Plastic covering

9 Abutment

10 Housing

11 Metal frame

12 Pressure spring

13 Opening

14 Semi-spherical cap

15 Cylindrical cavity

16 Central bore

17 Bores

18 Arch

19 Hollow cylinder

20 Upper end surface of the housing

21 Fixing apertures

22 Cushion

23 Lateral halves of the metal core

24 Groove

25 Guide opening

1. A doorstop, in particular for motor vehicles, having
a door retaining rod (1) articulated on a door assembly piece, door or door column parallel to the door pivot and
a retainer piece (2) fixed to the other door assembly piece,
the retainer piece (2) and the door retaining rod (1) which passes therethrough being moveably connected to each other by means of a catch device and
the catch device determining particular door opening positions and having brake and/or stop bodies (3), which
are movably supported in the retainer piece (2) against a spring force relative to the door retaining rod (1) and
are pre-tensioned against brake ramps (4) and catch depressions (5) on at least one side of the door retaining rod (1) transversely to the direction of movement,
characterized in that
the retainer piece (2) has a plastic housing (10) with an opening (13) for the door retaining rod (1) and guide openings (25) arranged perpendicular to the opening (13) and parallel to the pivot axis for the brake and/or stop bodies (3) which slide therein, and
the brake and/or stop bodies (3) are designed as sliding bodies in the form of hollow cylinders (19) closed at one end by means of a semi-spherical cap (14), which
in their open end accommodate a pressure spring (12) bearing on the closing cap (14) and guide this free of any tilt.

2. The doorstop as claimed in claim 1, characterized in that the brake and/or stop bodies (3)
project with their semi-spherical end into the opening (13)
as slide bodies bear pre-tensioned against sides of the door retaining rod (1) passing through the opening (13), these sides having the brake ramps (4) and catch depressions (5).

3. The doorstop as claimed in claim 1 or 2, characterized in that the brake and/or stop bodies are of plastic and the dome head of the cap (14) is truncated.

4. The doorstop as claimed in claim 1, 2 or 3, characterized in that the ends of the housing (10) are enclosed by U-shaped metal frames (11).

5. The doorstop as claimed in one of claims 1 to 4, characterized in that the pressure springs (12) are supported against the metal frames (11)

6. The doorstop as claimed in one of claims 1 to 5, characterized in that the door retaining rod (1) is composed of a metal core (7) covered with plastic and has a bearing eye (6) serving as pivot at one end and an abutment (9) as limit stop defining the open position of the door at the other end.

7. The doorstop as claimed in claim 6, characterized in that the brake ramps (4) and the catch depressions (5) are arranged on the sides of the door retaining rod (1) facing the pivot axis and are formed by or between bulges in the form of local thickenings of the plastic covering (8).

8. The doorstop as claimed in one of claims 1 to 7, characterized in that on its sides having the brake ramps (4) and the catch depressions (5) the door retaining rod (1) has a groove (24) running continuously in the longitudinal direction between bearing eye (6) and abutment (9), the profile of which groove complements the cap (14).

9. The doorstop as claimed in one of claims 1 to 8, characterized in that the abutment (9) is integrally formed with the door retaining rod, for example by a T-shaped design of the other end of the door retaining rod (1).

10. The doorstop as claimed in claim 9, characterized in that the abutment (9) is formed by ends of the two sides of the centrally divided metal core (7) bent at right-angles in opposite directions.

11. The doorstop as claimed in one of claims 1 to 10, characterized in that on its walls arranged perpendicular to the guide openings (25) the opening (13) has arches (18), the convexly rounded dome heads of which are arranged on a level with the guide openings (25), align with their inner wall and laterally guide the door retaining rod (1) perpendicular to the catch profile thereof.

12. The doorstop as claimed in one of claims 1 to 11, characterized in that the bearing eye (6) is extended parallel to the pivot axis by forming out the flat material section forming the metal core (7) parallel to the pivot axis.

13. The doorstop as claimed in one of claims 1 to 12, characterized in that the opening (13) is dimensioned so that the door retaining rod (1) can be introduced with its end having the bearing eye (6) foremost.

14. The doorstop as claimed in one of claims 1 to 13, characterized in that the closing cap (14) has a central bore (16) accessible from the cylindrical cavity (15) and further bores (17) arranged in a circle around the central bore (16), the wall thickness between the central bore (16) and the other bores (17) and between the latter, or between the central bore (16) and the outer surface of the brake and/or stop body (3) being approximately equal.

15. The doorstop as claimed in one of claims 1 to 14, characterized in that the outer surface of the cylindrical part (19) of the brake and/or stop body (3) is fluted in the direction of movement.

16. The doorstop as claimed in one of claims 2 to 15, characterized in that fixing apertures (21) are provided in the underside of the metal frames (11).

17. The doorstop as claimed in one of claims 1 to 16, characterized in that upwardly projecting cushions (22) of elastic material are integrally arranged in the upper end surface (20) of the housing (10) between the end of the metal frame (11) and the opening (13).

18. The doorstop as claimed in one of claims 1 to 17, characterized in that the profile of the opening (13) is shaped in such a way that the door retaining rod (1) is capable of swiveling by at least plus/minus 12.5° about the axis that is formed by the brake and/or stop bodies (3) bearing pre-tensioned on opposite sides.
